(19) United States
(12) Patent Application Publication
(10) Pub. No.: US 2011/0198271 A1
(43) Pub. Date: Aug. 18, 2011

(54) WATER PURIFIER FOR OUTDOOR

(76) Inventors: Kwi-Soon Lee, Seoul (KR); Kwi-Hee Lee, Busan (KR)

(21) Appl. No.: 12/279,977

(22) PCT Filed: Mar. 27, 2008
(86) PCT No.: PCT/KR2008/001724

§ 371 Date: Aug. 27, 2010

(30) Foreign Application Priority Data
Mar. 30, 2007 (KR) 10-2007-0031325

(51) Int. Cl. B01D 35/00; C02F 1/28

(52) U.S. Cl. 210/85

(57) ABSTRACT

An outdoor water purifier using a ceramic filter is disclosed. The outdoor water purifier is installed in home water pipes or water supply pipes for various industrial purposes to sterilize water and improve water purity. The outdoor water purifier includes a water gauge that measures the flow of tap water to calculate the water use rate, a filter connected to the water gauge for filtering tap water, a filter alarm that measures the state of the filter, and an RF transmitter connected to the filter for wirelessly transmitting data of tap water use rate according to the amount of tap water used. The filter is installed to a water supply pipe and configured in such a way that a carbon layer, a ceramic layer, an antibacterial layer, and a fine ceramic layer, stacking from the top thereof, in order to improve taste and to remove odor and bacteria contained in raw water.

### TECHNICAL FIELD

The present invention relates to an outdoor water purifier using a ceramic filter, installed in home water pipes or water supply pipes for various industrial purposes, which sterilize water and improve the purity of water that flows through the water pipes or the water supply pipes. More particularly, the present invention relates to an outdoor water purifier using a ceramic filter that includes a water gauge that measures the flow of tap water, to calculate the water user rate, a filter connected to the water gauge for filtering tap water, a filter alarm that measures the state of the filter, and an RF transmitter connected to the filter for wirelessly transmitting data of tap water use rate according to the amount of tap water used. The filter is installed to a water supply pipe and configured in such a way that a carbon layer, a ceramic layer, an antibacterial layer, and a fine ceramic layer, stacked from the top thereof, in order to improve water taste and to remove smell and bacteria and other contaminants in raw water.

### BACKGROUND ART

Water is essential for humans. Water pollution has increased as a result of industrial and economic development to the point that much raw water cannot be used as drinking water. As a result of water pollution, consumers increasingly mistrust tap water quality, and accordingly, few used tap water as drinking water.

A survey shows that the distrust in tap water is higher in metropolitan areas than in local areas: In metropolitan areas, 1.2% of the residents drink tap water as it is, 60.4% boil tap water, and 24.4% filter tap water by using indoor purifier. It has also been reported that up to 14.1% of the residents never drink tap water but use spring water, underground water and mineral water, etc.

Generally, tap water is produced after raw water is purified in an intake station and then supplied to homes and various industrial facilities. While the tap water is supplied to homes through water supply pipes from the intake station, rust or foreign materials caused by deterioration of the water supply pipes contaminate tap water, so that consumers increasingly mistrust tap water quality.

Thus, tap water should be boiled to be used as drinking water or purified by using an indoor purifier to remove the foreign materials, etc. These processes cause user inconvenience.

Harmful micro-organisms contained in tap water also degrade the purity of water and cause bad smell, so that tap water cannot be used as it is for drinking water.

In an effort to solve such problems, a water activating system having a purification function is disclosed in Korean Patent Publication No. 10-1997-0015476 published Apr. 28, 1997 and Korean Patent No. 10-0473103 issued Dec. 23, 2004. The conventional water activating system has functions of disinfection and purification directed to strengthen sterilization and anti-bacterial characteristics.

A water purifier for magnetized water having a reduction function is also disclosed in Utility Model Registration No. 20-0409429 issued Feb. 22, 2006. The conventional water purifier for magnetized water filters foreign or harmful materials contained in raw water to produce drinking water.

Although the conventional water activation system and conventional water purifier purify raw water using permanent magnets and ceramic balls, they are not good for removing odors or have poor anti-bacterial characteristics. In particular, the conventional water purifier disclosed in Utility Model Registration No. 20-0409429 re-processes raw water rather than using raw water introduced through the water supply pipe as it is, causing user inconvenience.

### DISCLOSURE

### Technical Problem

The present invention solves the above problems, and provides an outdoor purifier using a ceramic filter having a structure of a plurality of filter layers stacked to thereby easily produce clean water from raw water introduced through a water supply pipe without the necessity of filtering and boiling the raw water or without the necessity of using an indoor purifier.

### Technical Solution

In accordance with an exemplary embodiment of the present invention, the present invention provides an outdoor purifier using a ceramic filter, which includes: a water gauge, mounted in a water supply pipe, for gauging the tap water flow rate to calculate the water use rate; a filter, connected to the water gauge, for filtering tap water; a filter alarm for measuring a state of the filter; and a wireless rate data transmitter that is connected to the filter and wirelessly transmits rate data according to tap water usage amount.

The filter is shaped as a column having a diameter of about 5˜9 cm and a length of 25.4˜50 cm. The filter includes: a carbon layer including activated carbon of 350˜500 g that fills; a ceramic layer including ceramic balls fabricated by mixing sericite of 25˜35 wt % and silica of 65˜75 wt % and firing the mixture at about 1,000˜1,100° C.; an antibacterial layer including antibacterial balls fabricated by mixing bentonite of 35˜60 wt %, feldspar of 20˜35 wt %, and antimicrobial of 20˜30 wt % selected from silver (Ag) or titanium (TiO₂), and by firing the mixture at about 1,000˜1,100° C.; and a fine ceramic layer including fine ceramic balls fabricated by mixing bentonite of 35˜65 wt %, feldspar of 15˜30 wt %, and calcium of 20˜35 wt %, and by firing the mixture at about 1,000˜1,100° C. Here, the carbon layer, ceramic layer, antibacterial layer, and fine ceramic layer are sequentially located from the top of the filter.

### Advantageous Effects

As described above, the outdoor water purifier using a ceramic filter, according to the present invention, can completely remove odors from the raw water using the carbon layer of the filter and antimicrobially process harmful materials using a plurality of ceramic layers of the filter, thereby proving clean and safe tap water to consumers. The outdoor water purifier, according to the present invention, can allow user to use tap water as it is without the use of the indoor water purifier.

### DESCRIPTION OF DRAWINGS

The features and advantages of the present invention will be more apparent from the following detailed description in conjunction with the accompanying drawings, in which:

FIG. 1 is a perspective view illustrating an outdoor purifier according to an embodiment of the present invention; and

FIG. 2 is a cross-sectional view illustrating a filter according to an embodiment of the present invention.

### BRIEF DESCRIPTION OF SYMBOLS IN THE DRAWINGS

1: water gauge

2: filter

3: RF rate data transmitter

21: filter alarm

100: inflow pipe

200: outflow pipe

201: carbon layer

202: ceramic layer

203: antibacterial layer

204: fine ceramic layer

### BEST MODE

Now, preferred embodiments of the present invention are described in detail with reference to the accompanying drawings.

The outdoor purifier using a ceramic filter according to an embodiment of the present invention includes: a water gauge; a filter connected with the water gauge for filtering tap water; a filter alarm measuring the state of the filter; and an RF rate data transmitter connected with the filter for wirelessly transmitting rate data according to tap water usage amount. The water gauge is installed in a water supply pipe in order to gauge the quantity of tap water flow to calculate the water use rate.

The filter connects its one end to an inflow pipe to which the water gauge is installed and its opposite end to an outflow pipe. The filter alarm is installed to the filter.

The filter alarm sets a filter replacement time therein, so that a buzzer sound can be generated at 10 to 15 days ahead of the set date to thus signaling that a filter should be replaced.

The RF rate data transmitter is an element of a system that allows an inspection center of a control office to automatically check the amount of tap water used by a purifier installed in an apartment, house, or an office, etc., and to conveniently search for measured data using a computer, without having to visit each household by a water meterman. The RF rate data transmitter detects an operation and a stoppage of the water gauge and transmits data of the usage amount to a remote terminal in a wired/wireless method.

The filter corresponding to the primary technical element of the present invention is described in detail as follows.

The filter is formed by sequentially stacking a carbon layer, a ceramic layer, an antibacterial layer, and a fine ceramic layer.

The carbon layer serves to adsorb chlorine, odor or taste, gas and organic synthetic material contained in raw water by using activated carbon. The carbon layer is configured in such a way to fill activated carbon of 350˜1,000 g in a column whose diameter is 5˜9 cm and length is 25.4˜50 cm.

The diameter and length of the column used in the carbon layer is set according to the amount of the activated carbon. In the present embodiment, a usage amount of the activated carbon is 350˜1,000 g. When the activated carbon used is less than 350 g, odor cannot be effectively removed from raw water introduced through the water supply pipe. When the activated carbon used is more than 1,000 g, the length of the column is increased. This requires a reduction in the thickness of other layers, such as a ceramic layer, thereby causing deterioration in the antibacterial process. It is thus preferable that the activated carbon used is in the range of 350˜1000 g.

The activated carbon is obtained by carbonizing and activating a carbon material or a material containing carbon and is a type of amorphous carbon having a large inner surface area and strong adsorptive power. The activated carbon includes elements, such as a small amount of oxygen, hydrogen, nitrogen, sulfur, etc., ash and moisture, as well as carbon.

The activated carbon is a special carbon obtained by plastically activating coconut peel, wood, coal, etc., as raw materials. In the process of activation, micro-pores of an approximate size of molecules are formed well to have a specific surface area of about 800˜1,700 m² per 1 g. That is, the activated carbon has well-formed micro-pores, compared with other adsorbents. In recent years, the activated carbon has been developed to have a specific surface area up to 3,000 m²/g.

The micro-pore structure of the activated carbon is classified into a micro-pore of 20 Å or smaller, a meso-pore of 20˜1,000 Å, and a micro-pore of 1,000 Å or greater. The specific surface area of the activated carbon is mostly taken by the micro-pores. Micro-pores exert its adsorptivity to adsorb gas phase, and adsorption of micro-pores is most important. On the contrary, meso-pores exert its adsorptivity to adsorb liquid phase due to the relatively large size of adsorbed molecules.

The fabrication of activated carbon used for the carbon layer, according to the present invention, is described as follows.

First, a piece of oak is heated to 350˜370° C. and dehydrated. The dehydrated oak is heated to 600˜730° C. to disconnect oxygen bond thereof so that oxygen can be discharged in the form of water, carbon monoxide, carbon dioxide, etc. After that, volatile matter is removed at a temperature of 700° C. or higher, and the resultant material is then heated to 800˜850° C. to cause dehydrogenation.

Next, an activation process is performed to form micro-pores in the activated carbon. That is, the surface of carbide is eroded by an oxidation reaction of carbon at 800˜1,000° C. to form a micro-pore structure of the carbide to fabricate the activated carbon.

The ceramic layer serves to remove floating matters having a pore size of about 0.1˜1 μm contained in raw water as well as to perform a sterilization function. The ceramic layer is fabricated by filling ceramic balls that are formed by mixing 24˜35 wt % of sericite and 65˜75 wt % of silica (or glass) and baking the mixture at 1,000˜1,100° C.

The sericite is obtained in such a way that: a sericite ore is crushed; the crushed sericite ore is pulverized for four to six hours at 1,000˜1,500 rpm by using an alumina ball and milled into particles of 1˜3 μm. The sericite refers to an ore of the family of muscovite made of fine particles. The sericite is named because the surface of the structure is glossy like silk. Sericite is in general referred to as fine grained mica, but is actually called muscovite whose degree of particle size is very small.

Sericite has a chemical composite characteristic where the ratio of SiO₂/Al₂O₃ is large, the amount of K₂O is small, and H₂0 is sufficient, compared with muscovite. However, some type of sericite is the same chemical composite as muscovite. In general, the feature and composite of the sericite is between muscovite and illite.

The ceramic ball has a component ratio of sericite of 25˜35 wt % with respect to silica. When sericite used is less than 25 wt %, the ceramic ball decreases its strength and adsorptivity. When sericite used is over 35 wt %, the ceramic ball is disadvantageous in that the firing temperature is increased. Therefore, it is preferable that the ceramic ball is fabricated in such a way to use sericite of 25˜35 wt % with respect to silica.

The silica is a fine grained powder. When silicic acid is added to the find grained powder, silica sol having primary particles is produced. Silanol radical, Si—OH, on the surface of the primary particle forms a network of Si—O—Si according to the dehydration-condensation reaction is rapidly accelerated by continuous addition of acid, thereby forming a three-dimensional network structure, which is called a silica gel. After that, the silica gel undergoes washing and drying processes and become granular, thereby forming fine grained silica.

Silica of 65˜75 wt % is used for the ceramic ball. When silica used is less than 65 wt %, the ceramic ball is disadvantageous in that the firing temperature is increased. When silica used is over 75 wt %, the ceramic ball decreases its strength. Therefore, it is preferable that the ceramic ball is fabricated in such a way to use silica of 65˜75 wt % with respect to the whole weight thereof.

The antibacterial layer whose numerous pores of 0.1˜0.3 μm are coated with silver particles serves to process coliform bacilli and harmful bacteria, called sterilization and deodorization functions. The antibacterial layer is formed by filling antibacterial balls that are fabricated in such a way that 35˜60 wt % of bentonite, 20˜35 wt % of feldspar, and 20˜30 wt % of a type of antimicrobial agent are mixed and then baked at about 1,000˜1,100° C.

Bentonite is a clay having ultra-fine particles, consisting mostly of montmorillonite which is formed as glass components of volcanic ash is decomposed, and which has a large viscosity.

Most of bentonite swells in water. Some of bentonite do not swell, which is called acid clay. Bentonite has a principal component of montmorillonite and also includes quartz, cristobalite, zeolite, feldspar, pyrophyllite, silica gel, iron ore, organic matters, etc.

Bentonite shows a swell property, caking property, cation exchange property, etc. due to the feature of montmorillonite as a principal component thereof, and is thus used in various fields. For example, bentonite is used for ceramic ware in the field of inorganic matter to increase plasticity and strength of the heat-resistant matter.

Bentonite of 35˜60 wt % is used for the antibacterial ball with respect to the whole weight. When bentonite used is less than 35 wt %, the ceramic ball decreases its strength. When bentonite used is over 60 wt %, the ceramic ball is disadvantageous in that the adsorptivity of micro-bacteria contained in the raw water is decreased. Therefore, it is preferable that the ceramic ball is fabricated in such a way to use bentonite of 35˜60 wt % with respect to the whole weight thereof.

Feldspar is crushed for 2˜3 hours at 1,200˜1,400 rpm using alumina balls to have a particle size of 0.1˜1 mm.

Feldspar includes orthoclase, microline, albite, anorthite, plagioclase, etc.

Orthoclase has a chemical formula, K₂O.Al₂O₃.6SiO₂ or KAlSi₃.O₈, in which part of K is substituted for Na. In general, orthoclase is translucent.

Microline has a composition the same as orthoclase, i.e., K₂O.Al₂O₃.6SiO₂. Microline is shiny like glass. Microline colored white or yellow-white. The transparency of microline is various from transparent to opaque.

Albite has a chemical formula, K₂O.Al₂O₃.6SiO₂ or NaAlSi₃.O₈. The crystal structure of albite is shaped as small particle or laminate lump.

Anorthite has a chemical formula, CaO.Al₂O₃.2SiO₂ or CaAl₂Si₂.O₈. Anorthite has less than 10% of albite that always contains Na. Most of anorthite is white, however, it some of anorthite is transparent or opaque.

Plagioclase is contained in igneous rock and metamorphic rock as a principal component.

Feldspar of 20˜35 wt % is used for the antibacterial ball with respect to the whole weight. When feldspar used is less than 20 wt %, the ceramic ball decreases its strength. When feldspar used is over 35 wt %, the ceramic ball is disadvantageous in that the antibacterial property is decreased. Therefore, it is preferable that the ceramic ball is fabricated in such a way to use feldspar of 20˜35 wt % with respect to the whole weight thereof.

The antimicrobial agent uses silver (Ag) or titanium (TiO₂), which is used as a photocatalyst material. The antimicrobial agent of 20˜30 wt % is used for the antibacterial ball. When the antimicrobial agent used is less than 20 wt %, the antibacterial layer decreases its bacterial processing function so that micro-bacteria cannot be effectively processed in the raw water. When the antimicrobial agent used is over 30 wt %, the antibacterial ball changes its color. Therefore, it is preferable to use an antimicrobial agent of 20˜30 wt % with respect to the whole weight thereof.

The fine ceramic layer serves to process the raw water in the final stage. The fine ceramic layer is formed by filling antibacterial balls that are fabricated in such a way that 35˜65 wt % of bentonite, 15˜30 wt % of feldspar, and 20˜35 wt % of calcium are mixed and then baked at about 1,000˜1,100° C.

Bentonite of 35˜65 wt % is used for the fine ceramic ball with respect to the whole weight. When bentonite used is less than 35 wt %, the fine ceramic ball decreases its strength. When bentonite used is over 65 wt %, the fine ceramic ball is disadvantageous in that the fining temperature is increased. Therefore, it is preferable that the fine ceramic ball is fabricated in such a way to use bentonite of 35˜65 wt % with respect to the whole weight thereof.

Feldspar of 15˜30 wt % is used for the fine ceramic ball with respect to the whole weight. When feldspar used is less than 15 wt %, the fine ceramic ball's strength decreases. When feldspar used is over 30 wt %, the fine ceramic ball is disadvantageous in that the firing temperature is increased. Therefore, it is preferable that the fine ceramic ball is fabricated in such a way to use feldspar of 15˜30 wt % with respect to the whole weight thereof.

Calcium of 20˜35 wt % is used for the fine ceramic ball with respect to the whole weight. When calcium used is less than 20 wt %, the fine ceramic ball is disadvantageous in that the firing temperature is increased. When calcium used is over 35 wt %, the fine ceramic ball's strength decreases. Therefore, it is preferable that the fine ceramic ball is fabricated in such a way to use calcium of 20˜35 wt % with respect to the whole weight thereof.

The bentonite used for the antibacterial ball and fine ceramic ball has features where water content is 150˜160%, strength is 1.5, specific gravity is 2.5, and refractive index is 1.5.

In the following description, the respective ceramic layer, antibacterial layer, and fine ceramic layer, included in the outdoor water purifier according to the present invention, are explained in terms of their components.

The ceramic ball used in the ceramic layer is fabricated by mixing sericite with silica and firing the mixture. The ceramic ball further includes Fe₂O₃, CaO, K₂O, and MgO as well as SiO₂ and Al₂O₃ as principal component thereof.

The antimicrobial ball used in the antibacterial layer is fabricated by mixing bentonite, feldspar, and antimicrobial agent and firing the mixture. The antimicrobial ball further includes Fe₂O₃, Na₂O, CaO, K₂O, MgO, and Ag as well as SiO₂ and Al₂O₃ as principal component thereof.

The fine ceramic ball used in the fine ceramic layer is fabricated by mixing bentonite, feldspar, and calcium and firing the mixture. The fine ceramic ball further includes Fe₂O₃, CaO, K₂O, and MgO as well as SiO₂, Al₂O₃, and Na₂O as principal component thereof.

The embodiments of the present invention are implemented as follows:

### Embodiment 1 Ceramic Ball

Sericite of 32 kg and silica (glass) of 68 kg are mixed and then fired at 1,050° C.

### Embodiment 2 Antibacterial Ball

Bentonite of 49 kg, feldspar of 26 kg, and antimicrobial agent of 25 kg are mixed and then fired at 1,050° C.

### Embodiment 3 Fine Ceramic Ball

Bentonite of 45.5 kg, feldspar of 24.5 kg, and calcium of 30 kg are mixed and then fired at 1,050° C.

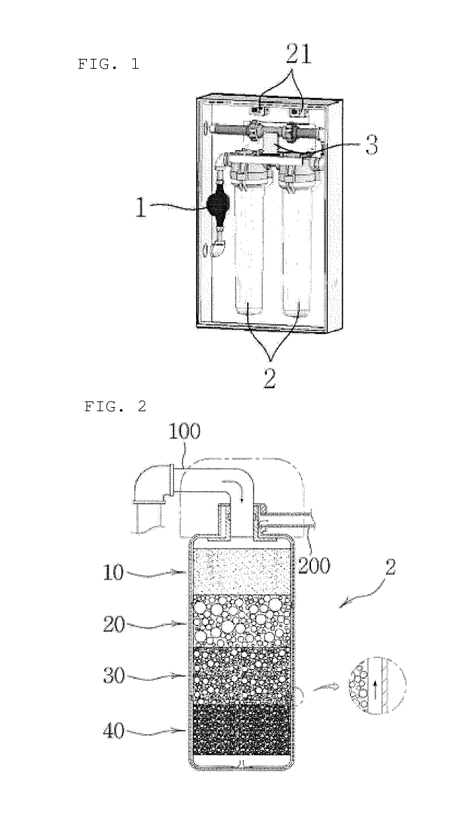

In the following description, the embodiments of the present invention are explained in detail with reference to the drawings. FIG. 1 is a perspective view illustrating an outdoor purifier using a ceramic filter according to an embodiment of the present invention. FIG. 2 is a cross-sectional view illustrating a filter 2 according to an embodiment of the present invention.

The filter 2 includes a carbon layer 201, a ceramic layer 202, an antibacterial layer 203, and a fine ceramic layer 204, which are serially stacked from the top, so that raw water introduced through an inflow pipe 100 can flow from the carbon layer 201 located at the top to the fine ceramic layer 204 at the bottom and then be discharged through an outflow pipe 200 to homes, etc. as tap water.

The outdoor purifier using a ceramic filter according to an embodiment of the present invention includes: a water gauge 1 mounted in a water supply pipe for gauging the tap water flow rate to calculate the water use rate; a filter 2 connected with the water gauge 1 for filtering tap water; a filter alarm 21 for measuring a state of the filter 2; and an RF rate data transmitter 3 connected with the filter 2 for wirelessly transmitting rate data according to tap water usage amount.

The filter 2 includes a carbon layer 201, a ceramic layer 202, an antibacterial layer 203, and a fine ceramic layer 204, which are serially stacked from the top.

The ceramic layer 202 filters floating materials, whose pore size is 0.1˜1 m, contained in the water in which taste and smell are removed through the carbon layer 210.

The antibacterial layer 203 contains antimicrobial materials and antimicrobially processes micro-bacteria contained in the water in which the floating materials are removed through the ceramic layer 202. The antibacterial layer 203 processes bacteria contained in the water itself and bacteria multiplied in the carbon layer 201 which is caused because the carbon layer 201 is used for a relatively long time and thus the adsorption ability of the activated carbon is deteriorated.

The fine ceramic layer 204 is a final layer that processes the raw water and discharges the purified water as tap water. That is, the raw water undergoes antibacterial and deodorization processes of the fine ceramic layer 204 and thus purified water is discharged as tap water.

In the following description, the test result of the embodiment of the present invention is explained.

TABLE 1
Test result of fine ceramic ball

| Sample | Item | Result | Analysis method |
|---|---|---|---|
| Fine | SiO₂ (Wt %) | 53.8 | Device analysis |
| ceramic | Al₂O₃ (Wt %) | 15.0 | (ICP-OES) |
| ball | CaO (Wt %) | 5.50 | KS L 3128-1999 |
| | MgO (Wt %) | 0.26 | |
| | Na₂O (Wt %) | 15.9 | |
| | K₂O (Wt %) | 6.74 | |
| | Fe₂O₃ (Wt %) | 0.66 | |
| | TiO₂ (Wt %) | 0.11 | |
| | Ba (Wt %) | 0.71 | |
| | ZnO (W t %) | 0.23 | |
| | AG (Wt %) | 0.04 | |

Table 1 shows a test analysis result of the components of the fine ceramic ball, issued No. 2005-1177, executed by Korea Institute of Ceramic Eng. & Tech.

TABLE 2
Test result

Result

| | | Prepared | 8 hrs | 24 hrs |
|---|---|---|---|---|
| Item | Unit | water | later | later |
| Coliform | CFU/mL | 1.6 × 10³ | Non- | Non- |
| bacillus | | | detection | detection |

Table 2 shows a test result of coliform bacillus detection, receipt No. KEWW10506022, executed by Korea Environment & Water Works Institute. The test is performed under the conditions where tap water of 50 L flows at 1.2 L/min; prepared water of 2 L flows; the filter including the fine ceramic and antimicrobial layer is filled with the prepared water; and the filled water is tested (which is left at room temperature).

TABLE 3
Test result

| Test item | Unit | Result |
|---|---|---|
| Pb | mg/L | Non-detection |
| Cd | mg/L | Non-detection |
| As | mg/L | Non-detection |
| Fe | mg/L | Non-detection |
| Mn | mg/L | Non-detection |
| Cr | mg/L | Non-detection |
| Zn | mg/L | Non-detection |
| Cu | mg/L | Non-detection |
| Al | mg/L | Non-detection |
| Mg | mg/L | Non-detection |
| Ag | mg/L | Non-detection |
| Ti | mg/L | Non-detection |
| Hg | mg/L | Non-detection |

Table 3 shows a test result of component detection, receipt No. KEWW10506028A, executed by Korea Environment & Water Works Institute. The test is performed: after a serial of procedure is performed twice where water of 2 L is adjusted to be pH 8 using distilled water, sample of 1.2 kg is soaked the water for 1 hour, elution is performed, and the effluent is thrown away, and then the third effluent as a test object is analyzed by ICP.

TABLE 4
Test result

| Emission rate | Emission Energy |
|---|---|
| (5~20 μm) | (W/m² · μm, 37° C.) |
| 0.980 | 3.50 × 10² |

Table 4 is a test result of emission rate and emission energy of fine ceramic, issue No. KFI-485, executed by Korea Far Infrared Association Co.

TABLE 5
Test result

| | | | Concent. | Reduction |
|---|---|---|---|---|
| | | Initial | Of 24 hrs | rate (%) |
| Test item | Sample | concent. | later | of bacteria |
| Antibacterial | Blank | 2.7 × 10⁶ | 7.7 × 10⁷ | — |
| test by | Fine | | <1.0 × 10⁴ | 99.9 |
| coliform | ceramic | | | |
| bacillus | filter | | | |
| Antibacterial | Blank | 3.4 × 10⁷ | 9.4 × 10⁷ | |
| test by | Fine | | <1.0 × 10⁵ | 99.9 |
| Pseudomonas | ceramic | | | |
| aeruginosa | filter | | | |

Table 5 is an antibacterial test result of coliform bacillus, issue No. KFIA-279, executed by Korea Far Infrared Association Co. The used strain is Escherichia coli ATCC 25922, Pseudornonas aeruginosa ATCC 15442 (In Table 5, “Blank” represents a state where it is detected without the sample, and the number of strain in the badge is calculated by multiplying the dilute multiplication).

TABLE 6
Test result

| | | Blank | Sample | |
|---|---|---|---|---|
| | Time | concent. | concent. | Deodorization |
| Item | (min) | (ppm) | (ppm) | rate (%) |
| Deodorization | Beginning | 500 | 500 | — |
| test | 30 | 490 | 100 | 80 |
| | 60 | 480 | 80 | 83 |
| | 90 | 460 | 70 | 85 |
| | 120 | 450 | 65 | 86 |

Table 6 is a test result of deodorization of a fine ceramic, issued number KFIG-257, executed by Korea Far Infrared Association Co. (In Table 6, test method: KFIA-FI-1004; and Test gas: ammonia).

TABLE 7
Test result

| Sample/Item | Anion (ION/cc) |
|---|---|
| Fine ceramic (Green) | 722 |

Table 7 is a test result of anion of fine ceramic (green), issue number KFIG-257, executed by Korea Far Infrared Association Co. (Table 7 shows anions emitted from the test object, based on the number of anions per a unit volume, which is performed under the conditions where test method: KFIA-FI-1042; test sample: 20 g; indoor temperature of charged particle measurement: 27° C.; humidity: 50%; and number of anions in air: 104/cc).

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An water purifier using a ceramic filter comprising: a water gauge (1), mounted in a water supply pipe, for gauging tap water flow rate to calculate water use rate; a filter (2), connected to the water gauge, for filtering tap water; a filter alarm (21) for measuring a state of the filter; and a wireless rate data transmitter (3) that is connected to the filter and wirelessly transmits rate data according to tap water usage amount,
wherein the filter (2) is shaped as a column having a diameter of about 5˜9 cm and a length of 25.4˜50 cm, and comprises:
a carbon layer (201) filled with activated carbon of 350˜500 g;
a ceramic layer (202) including ceramic balls fabricated by mixing sericite of 25˜35 wt % and silica of 65˜75 wt % and firing the mixture at about 1,000˜1,100° C.;
an antibacterial layer (203) including antibacterial balls fabricated by mixing bentonite of 35˜60 wt %, feldspar of 20˜35 wt %, and antimicrobial of 20˜30 wt % selected from silver (Ag) or titanium (TiO₂), and by firing the mixture at about 1,000˜1,100° C.; and
a fine ceramic layer (204) including fine ceramic balls fabricated by mixing bentonite of 35˜65 wt %, feldspar of 15˜30 wt %, and calcium of 20˜35 wt %, and by firing the mixture at about 1,000˜1,100° C.,
wherein the carbon layer (201), ceramic layer (202), antibacterial layer (203), and fine ceramic layer (204) are sequentially located from the top of the filter (2).

2. The water purifier according to claim 1, wherein the activated carbon is fabricated by heating and dehydrating a piece of oak at 350˜370° C., heating the dehydrated oak at 600˜730° C., heating the oak, at 800˜850° C. to cause dehydrogenation, and performing an activation process,
wherein the activation process is performed to form micro-pores in the surface of a carbide thus formed, wherein the micro-pores are formed by erosion of the surface by an oxidation reaction of carbon at 800˜1,000° C.

3. The water purifier according to claim 1, wherein the sericite is obtained by: crushing a sericite ore; and pulverizing the crushed sericite ore for four to six hours at 1,000˜1,500 rpm using an alumina ball mill into particles of 1˜3 μm.

4. The water purifier according to claim 1, wherein the feldspar is crushed for 2˜3 hours at 1,200˜1,400 rpm using an alumina ball mill to have a particle size of 0.1˜1 mm.

5. The water purifier according to claim 1, wherein the bentonite comprises clay mineral where water content is 150˜160%, strength is 1.5, specific gravity is 2.5, and refractive index is 1.5.
